(19) United States
(12) Patent Application Publication
(10) Pub. No.: US 2009/0307157 A1
(43) Pub. Date: Dec. 10, 2009

(54) FIELD CONDITION INDICATOR

(76) Inventor: Lori A. CARPENTER, Reno, NV (US)

Correspondence Address: Jeffery M. Lillywhite, PC, P.O. Box 1113, Draper, UT, 84020-1113, US

(21) Appl. No.: 12/478,761

(22) Filed: Jun. 4, 2009

Related U.S. Application Data
(60) Provisional application No. 61/081,958, filed on Jul. 18, 2008.
(60) Provisional application No. 61/058,804, filed on Jun. 4, 2008.

(51) Int. Cl. G06Q 90/00

(52) U.S. Cl. 705/500

(57) ABSTRACT

In a system for reporting field conditions, a method includes determining whether jurisdictional wetland conditions at a specific field location exist. When conditions are met for at least one of hydrology, soils and vegetation, a section of an indicator is filled in. The indicator is overlaid on a map to identify the specific field location.

### CROSS-REFERENCE TO RELATED APPLICATIONS

This application claims the benefit of U.S. Provisional Patent Application No. 61/081,958, entitled “Field Condition Indicator,” filed Jul. 18, 2008, and U.S. Provisional Patent Application No. 61/058,804, entitled “Interactive Database Driven Multitenancy System,” filed Jun. 4, 2008, which are incorporated herein by reference.

### BACKGROUND OF THE INVENTION

1. The Field of the Invention

The invention is related to methods and systems designed for wetland identification and delineation. More particularly, it is directed to methods and systems for indicating field conditions.

2. The Relevant Technology

Section 404 of the Clean Water Act regulates the discharge of dredged or fill material into waters of the United States (WOUS), including wetlands (see 33 CFR 320-330). Section 404 requires a permit before dredged or fill material may be discharged into WOUS. As part of the permit application process wetlands must be identified and delineated. This is done following the 1987 Corps of Engineers Wetlands Delineation Manual and Supplements to the manual, depending on the region where the project is located. The US Army Corps of Engineers (USACE or CORPS) and the US Environmental Protection Agency (USEPA) are the federal agencies enforcing Section 404 provisions. The US Fish and Wildlife Service and the National Marine Fisheries Service evaluate specific cases or policy issues pursuant to Section 404(q).

Wetland identification and delineation and the Section 404 permitting process is a rigorous procedure that not only involves understanding topics such as hydrology, geology (e.g., soils), and biology (e.g. vegetation) but up-to-date knowledge on regulations, policies, and rulings that affect how decisions are made. Companies must hire and retain employees that are capable of understanding the science and regulations to be current. These employees must not only keep up to date technically, but they need to keep current with ever changing policies and regulations.

Programs have been developed to help wetland delineators work through the Section 404 process but do not provide all the features and information required to conduct delineations and walk individuals through the process. The programs are not necessarily publicly available and do not allow individuals who are not technical experts to conduct wetland identification and delineations. The software is geared towards persons who are currently experts in the process. The existing programs do not simultaneously offer online interaction; good documentation and support; compatibility with recently updated USACE standards; national applicability; weekly/monthly updates; ease of use; support of field data collection; field data transfer; integration with Geographic Information Systems (GIS) and Remote Sensing (RS) technology, Global Positioning Systems (GPS), database technology, and visual formats; instant desktop delineation services; web GIS functions; data analysis capabilities; expandable forms; and wetland delineation training.

### BRIEF SUMMARY OF THE INVENTION

In a system for reporting field conditions, a method includes determining whether jurisdictional wetland conditions at a specific field location exist. When conditions are met for at least one of hydrology, soils and vegetation, a section of an indicator is filled in. The indicator is overlaid on a map to identify the specific field location.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

The following is a brief description of the figures used to illustrate the various embodiments of the invention.

FIGS. 1A-1E illustrate a set of indicators using color coded sections;

FIGS. 2A-2E illustrate a set of symbols used with the indicators to identify threatened and endangered species;

FIGS. 3A-3E illustrate a set of markings used with the indicators to identify atypical or problematic areas; and

FIGS. 4A and 4B illustrate the indicators to identify a wetland complex with an associated Rapanos Form.

### DETAILED DESCRIPTION OF THE VARIOUS EMBODIMENTS

Indicators are used to identify field conditions in a system designed to perform wetland identification and delineation. A well designed knowledge base, for example, can be used to instantly and efficiently perform wetland indicator identification to delineate wetlands automatically.

The knowledge base is provided to efficiently perform wetland indicator identification in a manner that overcomes many of the inefficiencies and associated monetary and time-cost under the current techniques in current practices. The system instantly provides users with the knowledge, instruction and judgments to facilitate the process effectively. Scientific and regulatory knowledge stored in a database is utilized by an expert system to determine the presence of these indicators and thus identify the wetland automatically. The web-based system for the United States and Territories with databases allows easy identification of wetlands and delineation of wetland boundaries as well as automation of the Section 404, Clean Water Act, permits application process.

The process can be accessed through the system for receiving wetland delineation service for an area of interest (AOI). The system is supported by a user interface, which allows users to submit project information, including the site location, site condition, and project boundary layers. The user interface for this method may also be designed to include the ability for users to submit plot data using the USACE standardized data forms from all districts including regional supplements, such as Alaska Delineation Module, Arid West Delineation Module, Arizona, New Mexico Mountains Wetlands, Atlantic and Gulf Coastal Plain Module, California Wetlands, Caribbean Islands Module, Columbia Snake River Basin Wetlands, Great Plains Module, Hawaii and Pacific Islands Module, Interior Deserts Wetlands, LRRB Wetlands, Mediterranean California Wetlands, Eastern Mountains and Piedmont Module, Midwest Module, Northcentral and Northeast Module, Pacific Islands Module, Sierra Nevada Mountains Wetlands, Western Mountains Valleys & Coast Module.

The system may include a designed user interface for service request, data submitting, report and maps downloading, and Section 404 submitting. The system may further include 1) a web server, which hosts web pages for user access for submitting information, interacting the wetland delineation proceeding, and requesting report and maps; 2) a database server, which hosts the knowledge base and rules database for the expert system, the spatial database for environmental data and the data point database; and 3) a processing server, which contains and executes the programs/software for implementing the above described method embodiments. The system may also include GPS, Personnel Digital Assistant (PDA), Printer, Plotter and Scanner to be used in the above method embodiments.

The wetland is identified interactively through the database driven expert system. The expert system includes procedures and rules used to determine the areas of hydrophytic vegetation presence, hydric soil presence, and wetland hydrology presence for the field survey plots entered for the AOI. The process identifies and determines wetland delineation and provides indicators for hydrophytic vegetation, hydric soil, and wetland hydrology, assisted by the knowledge base and rules from the expert system.

The expert system determines whether jurisdictional wetland conditions at a specific field location exist. When certain conditions are met, the expert system fills in a section of an indicator to identify conditions that are met for hydrology, soils or vegetation. The expert system overlays the indicator on a map to identify the specific field location.

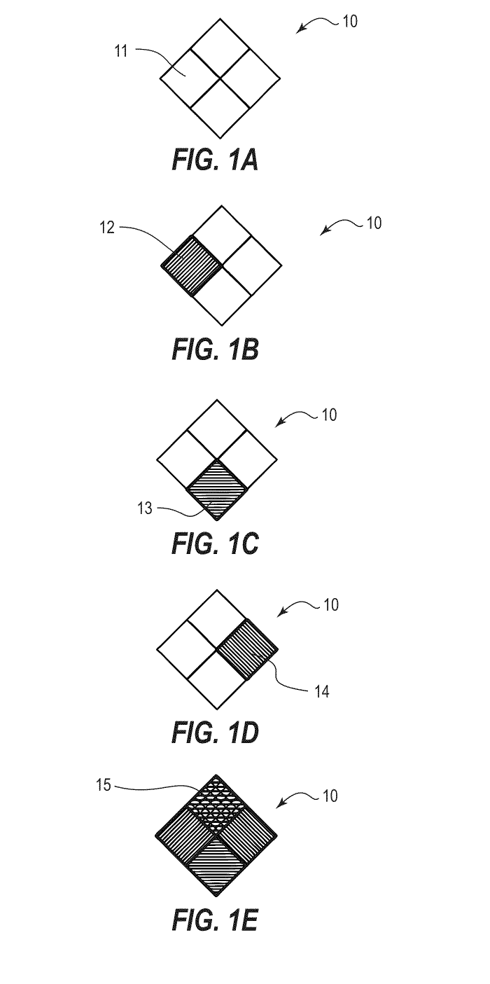

As illustrated in FIGS. 1A-1E, a field indicator 10 is generated by the expert system to represent a field condition. The field indicator 10 can include a diamond shape 11 divided into four sections. The indicator 10 conveys technical information to the reader to determine whether jurisdictional wetland conditions at a specific field location exist. The indicator 10 can be overlain on an aerial map of the study area or any base map that is available. The indicator 10 allows the map reader to understand the outcome of the technical survey without having to read the technical report. Wetland boundaries are present when three indicators are found, or found under field conditions. Those field indicators are hydrology, soils and vegetation, and when present are indicated by a section, such as a section, filled with the appropriate color. For example, the color for hydrology can be blue; soils can be red; and vegetation can be green. If all three indicators are present the fourth section is also filled in. The fourth section, for example, can be yellow.

A filled in first section 12 means that hydrologic indicators are met or present. As discussed above, this section 12 may be filled in with a blue color. A filled in second section 13 means that hydric soil indicators are met or present. As discussed above, this section 13 may be filled in with a red color. A filled in third section 14 means that hydrophytic vegetation conditions are met or present. As discussed above, this section 14 may be filled in with a green color. When all three conditions are met or present a fourth section 15 indicates to the map reader that all wetland conditions are present sufficient to meet US Army Corps of Engineers wetland boundary determination for that point and that the area is further mapped as a waters of the United States/wetland (WOUS/wetland). As discussed above, this section 15 may be filled in with a yellow color.

During the analysis, it is crucial for the analyzer to understand what areas on a property are uplands and which are WOUS/wetlands. Wetland delineation reports are often cumbersome. Detailed, complicated reports take hours to read and fully understand. This system allows the reader to understand which technical elements are most relevant without reading the report. It is ideal that the reader be able to immediately understand the report conclusions. This system saves the reader time because they can understand the conclusions without reading the report.

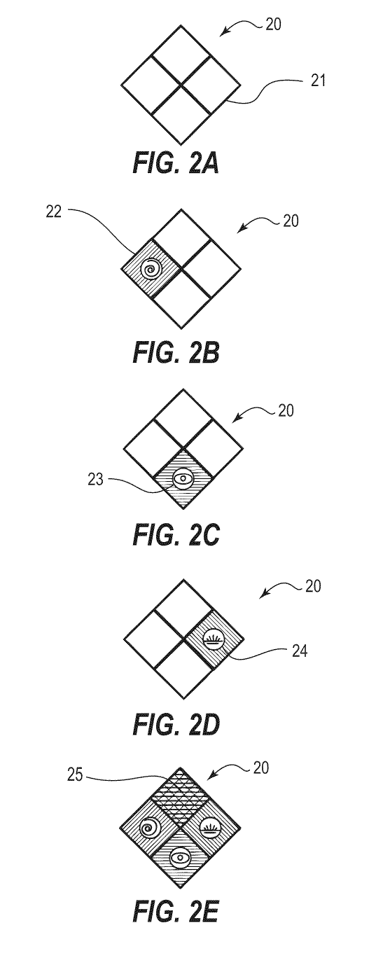

As illustrated in FIGS. 2A-2E, symbols can be added to the indicators 20 to identify whether threatened and endangered species (T&E) exist in uplands and wetlands for flora (vegetation) or fauna (animals). The field indicator 20 can also have a diamond shape 21 that is divided into four sections like the indicator 10 discussed above. The color coded sections in this embodiment can be the same as the indicator 10. If a T&E water species is found at the location, a first section can identify it with a symbol 22, for example, a ‘spiral circle’ image inside the blue or blue position section to identify the fauna. If a second section includes a symbol 23, such as an ‘eye’ image inside the red or red position section it means that a T&E species was found that is fauna. If a third section has a symbol 24, such as ‘grass’ image inside the green or green position section it means that a T&E vegetation species was found that is flora. Similar to the indicator 10 discussed above, if all three indicators are present the fourth section 25 is filled in.

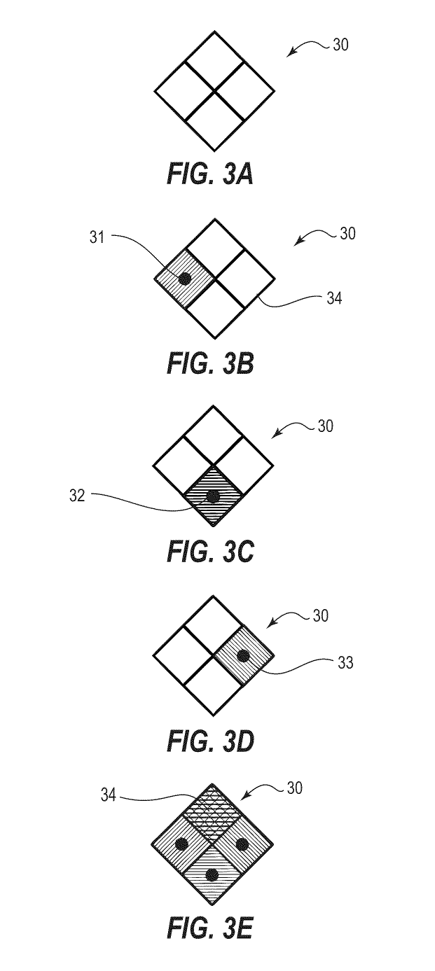

FIGS. 3A-3E illustrate a method of identifying when Corps protocol circumstances exist for atypical and problem areas. The field indicator 30 can be similar to the indicator 10 discussed above. If an atypical and/or problem area condition exists for a wetland indicator, the section can include a marking 31-33, such as a dark dot or filled in circle in that colored section. A note can be included to explain the circumstance on a mapping legend. As discussed above with respect to indicator 10, if all three indicators are present, the fourth section 34 is filled in.

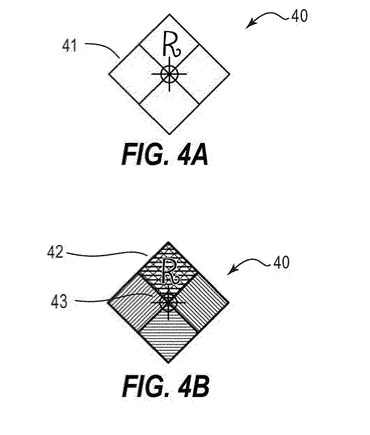

FIGS. 4A and 4B illustrate a method of identifying when a Rapanos Form is prepared for the associated wetland complex. The Rapanos Form is required by all districts and was implemented as a result of the Rapanos-Carabell decision. The Rapanos Form satisfies a requirement to record how wetlands are delineated and determined and ensures consistency between the districts. The field indicator 40 is similar to the indicator 10 discussed above having a diamond shape 41 and includes a character R 42 in one of the sections of the diamond shape 41. The character R 42 indicates that the Rapanos Form was or was not used. The field indicator can also include an anchor symbol 43 placed in the center of the diamond shape 41. The character r 42 can be placed in a section of the diamond shape 41 above the anchor symbol 43. To represent the presence of the Rapanos Form for the wetland complex, four sections of the field indicator 40 are filled in. To represent the absence of Rapanos Form, none of the four sections of the field indicator are filled in. A note can be included to further explain the circumstance on a mapping legend to someone reviewing the delineation results.

Although the indicators are illustrated with none, one, or all sections filled in, the indicators can include a variety of combinations of filled in sections, symbols or markings. The figures are meant to show some general examples of the field conditions. These conditions, however, can create an indicator with any combination of the filled in colors, symbols and markings depending on what was found or not found in the field.

This simple mapping system allows the reader to get to the mapping conclusions within minutes and independently decide whether it is necessary to read the report and if so which sections. The mapping system overlain on the aerial photograph allows the reader to see what the field scientist saw and make their own judgment. This will reduce report review and processing time and save both Federal and State agencies time and therefore Users of this system will have their reports processed faster and have a stronger client base and make more money per project due to speedy processing.

Examples of the system may include or be conducted to implement the indicator system using a special purpose or general-purpose computer, processor, or logic device including various computer hardware and devices, as discussed in greater detail herein or known to one of ordinary skill in the art. Embodiments within the scope of the present system can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise Random-Access Memory (RAM), Read-Only Memory (ROM), Electrically Erasable Programmable Read-Only Memory (EEPROM), Compact Disk Read Only Memory (CD-ROM) or other optical disk storage, magnetic disk storage or other magnetic storage devices, or any other medium which can be used to carry or store desired program code means in the form of computer-executable instructions or data structures and which can be accessed by a general purpose computer, special purpose computer, or other logic device.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the system. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system for reporting field conditions, a method comprising:
determining whether jurisdictional wetland conditions at a specific field location exist;
filling in a section of an indicator to identify when conditions are met for at least one of hydrology, soils and vegetation; and
overlaying the indicator on a map to identify the specific field location.

2. The method of claim 1, further comprising an act of filling in a fourth section when three other indicators are filled in.

3. The method of claim 1, further comprising an act of placing a symbol in a section to identify when threatened or endangered species exist.

4. The method of claim 3, wherein the symbol is placed in the section corresponding to a place where threatened or endangered species is found.

5. The method of claim 3, wherein the symbol is at least one of a spiral circle, an eye, and grass image.

6. The method of claim 1, wherein the indicator is a diamond shape, divided into four sections.

7. The method of claim 1, further comprising an act of placing a marking in a section to identify an atypical or problem area condition exists.

8. The method of claim 7, wherein the marking is at least one of dark dot and filled in circle.

9. The method of claim 1, further comprising an act of placing a character R in a section to identify use of a Rapanos Form.
